(19) United States
(12) Patent Application Publication
(10) Pub. No.: US 2021/0259166 A1
(43) Pub. Date: Aug. 26, 2021

(54) WEED GROWTH CONTROL AND WATER AND NUTRIENT CONSERVATION TECHNOLOGY

(71) Applicant: Ayyappan K. RAJASEKARAN, Glen Mills, PA (US)

(72) Inventor: Ayyappan K. RAJASEKARAN, Glen Mills, PA (US)

(21) Appl. No.: 17/183,531

(22) Filed: Feb. 24, 2021

Related U.S. Application Data
(60) Provisional application No. 62/980,678, filed on Feb. 24, 2020.

(51) Int. Cl. A01G 13/02; A01G 25/16; A01G 25/02

(52) U.S. Cl. CPC A01G 13/0268; A01G 2025/006; A01G 25/02; A01G 25/16

(57) ABSTRACT

Weed barrier systems of one or more long lasting weed barrier sheets of flexible polymer or plant material impervious to light and water with precut holes to grow a single to more than 100 plants of different sizes and/or open ended planters which inhibit or prevent weed growth and facilitate root zone targeted water and nutrient delivery are provided.

This patent application claims the benefit of priority from U.S. Provisional Application Ser. No. 62/980,678, filed Feb. 24, 2020, the teachings of which are incorporated by reference in their entirety.

### TECHNICAL FIELD

The present invention relates to systems that prevent weed growth and enable root zone targeted water and nutrient delivery to conserve water and fertilizers in gardens. The systems include an impervious weed barrier with holes and open cylinders or planters for insertions and growth of desired plants.

### BACKGROUND

Weeds are unwanted plants that grow quickly among desired plants in gardens. If the weeds are unchecked, they outgrow and overtake the garden. Weeds compete for nutrients, water and sunlight and interfere with the growth of the desired plants. Controlling and preventing weed growth is crucial to healthy maintenance and the aesthetic look of the garden.

Common weeds include lambsquarters, pigweed, crabgrass, nutsedge, canada thistle, dandelion, chickweed, purslane and quackgrass. Weeds produce a large number of seeds, rapidly multiply and grow, and have long-term survival. The seeds of weeds can withstand harsh conditions including extreme heat and cold but then sprout as soon as conditions become favorable. To an agriculturist and horticulturist, the weeds need to be controlled in an economical, practical and safe way to reap the fruit of their hard work.

An easy way to control weeds is to spray or add weed controlling chemicals into the soil. However, chemicals are often hazardous to health of humans and pets. Many types of products exist for controlling and preventing weeds; from selective herbicides (e.g. Weed-be-Gone), to complete herbicides (e.g. Round-up), to fiber barriers.

Selective herbicides are effective at controlling and killing existing weeds, however, they do not prevent new ones from growing. Also, selective herbicides may also harm desirable, broadleaf plants.

Complete herbicides are extremely effective at killing anything green and temporarily prevent new weeds from growing. However, as the name suggests, complete herbicides will kill both weeds and desirable plants, thus, limiting their use. Fiber barriers are nonwoven polymer fabrics also known as “landscape fabrics” or “geotextiles.” These are typically UV stabilized and sold in rolls to contractors or retail stores. The main purpose of fabric is to suppress weed growth while allowing water, air, herbicides, fertilizer, and insecticides to flow into the soil. Fabrics are used extensively in large farms, residential homes and gardens. Although the fabric largely prevents weed growth from the soil beneath temporarily, weeds often grow on the fabric whether covered by mulch or soil reducing their value as a weed barrier. Because of the porous nature of the fabric, the roots of weeds penetrate the fabric and ultimately grow well and spread. Moreover, depending on the quality of the fabric it has to be changed every season/year increasing cost to the gardener.

When plants are grown outdoors, watering and fertilizing are often done to the entire plant growing area rather than individual plants. This results in the waste of large amounts of water and fertilizer.

Root zone focused watering and fertilizing will conserve water and fertilizer, thus minimizing water usage and accumulation of chemicals in the soil.

A simpler, inexpensive, longer lasting approach to prevent weed growth and facilitate root zone focused watering and fertilizing is needed.

### SUMMARY OF THE INVENTION

An aspect of this disclosure relates to a weed barrier system comprising an impervious, long lasting, flexible sheet of polymer or plant material that is easy to apply and inhibits weed growth. Plants are grown in precut holes in this barrier. Each precut hole is capable of housing an open-ended cylinder for growing plants. Watering and fertilizing is performed within these open-ended cylinders, which facilitates root zone focused watering and nutrient application. Ability to water and apply fertilizer to the root zone conserves and prevents waste of both water and nutrients.

In one nonlimiting embodiment, the weed barrier is made of thin sheets comprising natural rubber, vulcanized rubber, neoprene, ethylene propylene diene monomer (EPDM), silicon, thick plastic comprising polypropylene, polyethylene, polyamide, polystyrene, or mixtures of these or woven sheets made grass, leaf, wood, bamboo or other plant materials. The weed barrier prevent weeds growth while retaining moisture of the soil below. Precut holes in the weed barrier sheet can vary from 0.5 to 10 inches in diameter to grow both small and large plants.

In some nonlimiting embodiments, the system further comprises a means for root zone focused watering and fertilizing. In these embodiments, the system further comprises a plurality of open ended cylinders comprised of high density polyethylene (HDPE), polyvinyl chloride (PVC) or polypropylene, polyethylene polyamide, polystyrene or mixtures of these, galvanized or non-galvanized iron or stainless steel or clay, terracotta, ceramic, wood or bamboo. The open-ended cylinders are partially buried in soil through the holes in the weed barrier sheet. Plants are then planted into the open end of the cylinder. The size of the cylinders could be from 0.5 to 10 inches in diameter to accommodate different sizes of plants. These water and nutrient conservators are designated as open-ended planters (OEP). In addition to retaining water and nutrients at the root zone, OEPs also block the weed seeds that are blown by the wind on the ground surface. This will further reduce weed growth in the soil-exposed area of the OEP.

Another aspect of this disclosure relates to a weed barrier system comprising one or more of these OEPs.

### BRIEF DESCRIPTION OF THE FIGURES

FIG. 1 is a diagram showing a weed barrier sheet comprising rubber with holes.

FIG. 2, views A and B, are diagrams showing a series of 4 square foot weed barrier sheets linked together via staples (view A) and the weed barrier with a longitudinal cut through the hole to wrap around existing plants (view B).

FIG. 3, views A, B, C and D are photographs showing an OEP made of steel (View A), a top view (View B), a side view of an OEP made of PVC (View C), and a side view of an OEP made of HDPE (View D).

FIG. 4 is a photograph showing a weed barrier sheet in use with an absence of weed growth on the rubber sheet. Weeds (see arrow) grow only on the exposed area of the soil.

FIG. 5 is a diagram of a weed barrier system connected with automatic watering by drip irrigation.

### DETAILED DESCRIPTION

In gardening, deweeding is the most time consuming and boring job. Unchecked, weeds often take over the growth of desired plants and ultimately strangle them to death. It is necessary to remove weeds on a continuous basis, which is laborious and expensive. Chemicals that can stop weed growth are easy to apply and effective. However, often these chemicals are health hazards to humans and pets. In addition, these chemicals have to be used repeatedly to check the growth of weeds.

In this disclosure, systems and methods to completely eliminate the need for weed controlling chemicals and provide root focused water and nutrient delivery are described. This approach also conserves water and nutrients making it more economical, earth friendly and an effective way to eliminate weeds from residential, industrial and publically maintained gardens and landscapes.

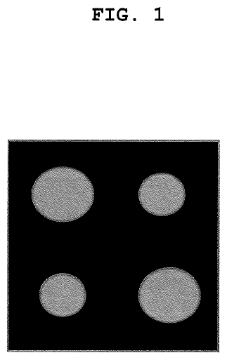

As depicted in FIG. 1, the weed barrier system comprises an impervious, flexible sheet of polymer or plant material that is easy to apply and inhibits weed growth. This weed barrier sheet can be comprised of a variety of materials including, but not limited to, natural rubber, vulcanized rubber, neoprene, ethylene propylene diene monomer (EPDM) rubber, silicon, thick plastic made of polypropylene, polyethylene, polyamide, polystyrene, or mixtures of these or woven sheets made of grass, leaf, wood, bamboo or other plant materials. The thickness of weed barrier sheet can range from 0.25 to 2.0 mm in thickness. In the nonlimiting embodiment, depicted in FIG. 1, the weed barrier sheet is 4 square feet of vulcanized natural rubber 2 mm thickness.

As shown in FIG. 1, there are precut holes in the weed barrier sheet through which plants are planted. These holes can vary from 0.5 to 10 inches in diameter to grow both small and large plants. Further, the weed barrier sheets can have two or more different sizes of holes depending on the plants to be grown. In one nonlimiting embodiment, the space between the adjacent holes is 6 inches and the holes in diagonal are 12 inches apart. However, distance between the holes can be adjusted depending on the plants to be grown. Accordingly, larger plants can be grown in diagonal holes. Some plants, like certain tomato varieties and brussel sprouts, grow larger and need to be planted on a sheet with a single hole.

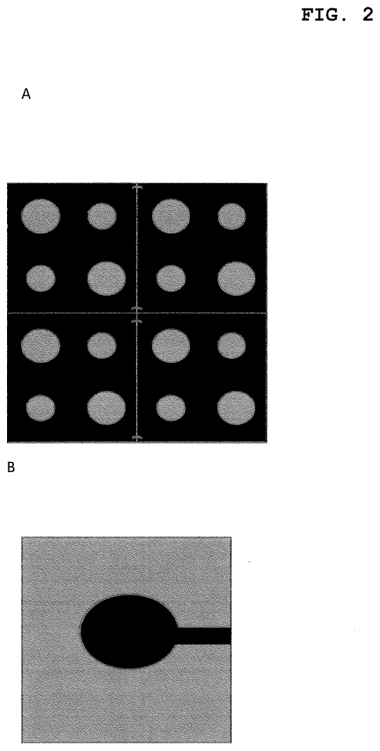

The weed barrier can be placed on a straight surface or uneven surface and can be stapled to the ground by regular garden staples or long nails to prevent being blown off by the wind. Further, multiple weed barrier sheets can be joined by stapling to cover larger areas (See, for example FIG. 2A). In sloped areas, the weed barrier sheets of this disclosure can also inhibit/prevent soil erosion. These weed barrier sheets can be washed and stored for repeated use for the next season or left as such since they can withstand cold winter or hot summer temperatures. In one nonlimiting embodiment, the weed barrier sheet can withstand minus 20° C. and up to 70° C. These weed barrier sheets are impermeable to light and water, thus completely blocking weed growth resulting from lack of light and water. During rain or over watering, water can enter only through the inter space between two or more sheets. However, this will not facilitate weed growth due to the absence of light. If the adjacent sheets are not properly spaced, weeds can grow in the gaps. These barriers maintain moisture below the sheet since the plants are spaced closely and watered regularly.

In some embodiments, the weed barrier sheet is provided on a large roll with pre-cut holes to cover large agricultural lands to grow vegetables and small fruits.

Weed barrier sheets of this disclosure can be used to grow a single to more than 100 plants of different sizes.

Further, the weed barrier sheets provide a means for chemical free growth of plants for organic gardening.

In some nonlimiting embodiments, the weed barrier sheets are modified to cover areas already growing plants or trees to prevent weeds interference. In this nonlimiting embodiment, the weed barrier sheet may be cut longitudinally along the hole to allow the weed barrier sheet to be wrapped around the trunk of an existing tree or plant or bush. See FIG. 2B.

In some nonlimiting embodiments, the appearance of the weed barriers sheets is modified to resemble mulch or green grass or to have alternative colors with different contours and shades.

In some nonlimiting embodiments, the weed barrier sheet further comprises an agent that repels rabbit and deer and other small animals from approaching the garden. A nonlimiting example of such an agent is sulfur.

The disclosure also provides for weed barrier systems comprising a means for root zone focused watering and fertilizing.

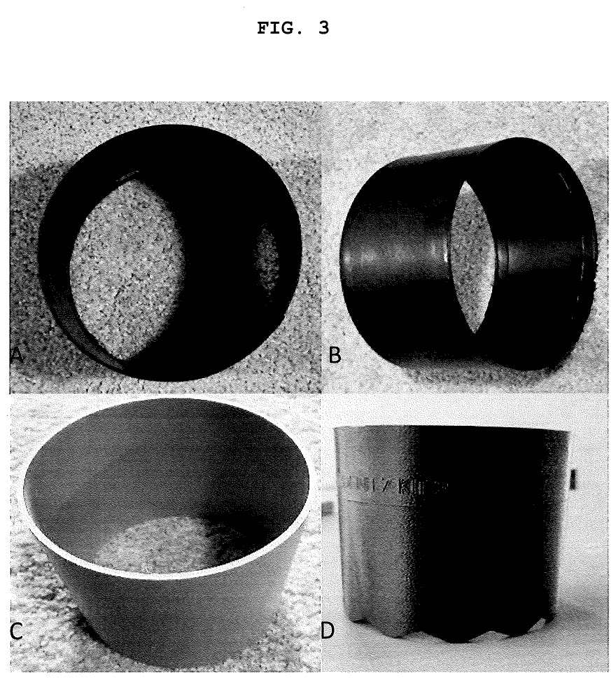

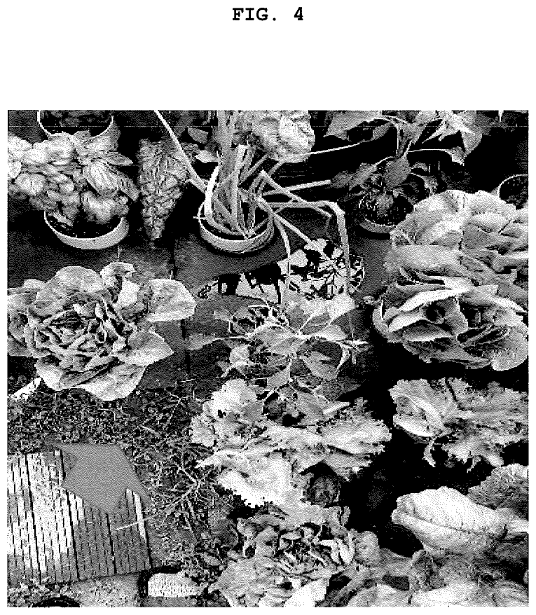

For example, referring to FIGS. 3 and 4, a weed barrier system of this disclosure may comprise a plurality of open-ended planters (OEPs). These OEPs can be used in combination with the weed barrier sheets of this disclosure, alone, or with other fabric or fiber based weed barriers.

When used with the weed barrier sheets disclosed herein, these open-ended cylinders are partially buried in soil through the holes in the weed barrier sheet. Plants are then planted into the open end of the cylinder for root zone focused watering and fertilizing.

OEPs can be made from a variety of materials including, but not limited to, galvanized iron, non-galvanized iron or stainless steel, polyvinyl chloride (PVC), or polypropylene, polyethylene, polyamide, polystyrene or mixtures of these, high density polyethylene (HDPE), or made of clay, ceramic or terracotta or plant materials like wood or bamboo. The diameter of the OEP can vary from 0.5 to 10 inches and its height can vary from 3-6 inches. At least two inches of the OEP is above the soil surface.

In the nonlimiting embodiments depicted in FIG. 3, the OEPs are made of non-galvanized iron, blackened by electroplating, PVC or HDPE, with a diameter of 4-6 inches and the height of 4 inches. The OEPs focus watering and fertilizing to the root zone. Since the area getting water is less and since the water does not run out of the OEP, the roots get ample amounts of water. At the same time, there is no wastage of water running into the adjacent area where it is not needed. Similarly, since the fertilizer is applied within the perimeter of the OEP less amount of fertilizer is needed just to feed the plant. In some nonlimiting embodiments, the OEP or soil within the OEP is modified to retain more water or prevent evaporation of water from the surface. For example, water storing polymer crystals such as soil vigor, soil moist, water storing crystals, or hydretain can be added to the soil surface within the OEP to reduce the frequency of watering thereby conserving water. In some nonlimiting embodiments, reservoirs containing/emitting animal repellants such as bobbex or liquid fence can be placed on the soil surface within the OEP to repel rabbits, deer and other small animals away from the garden.

Further, weeds produce abundant seeds which have the ability to be carried away by the wind on the ground surface. Another important function of the OEP is to block these wind-blown seeds from easily reaching the bottom of the desired plant. Since the OEP projects out of the soil, surface wind-blown weed seeds are blocked. In some nonlimiting embodiments, the outer surface of the OEP above the soil is modified to capture wind-blown seeds. For example, double-sided tape can be applied to a section of the OEP above ground to capture weed seeds. Such tape can be regularly replaced.

In addition, there is no water on the weed barrier sheets for seeds to germinate. Even if the seed germinates the weed barrier sheet is impervious for the roots. Thus, the weed barrier sheet and the OEP combination almost completely eliminate weeds (See FIG. 4).

In one nonlimiting embodiment, the weed barrier sheet is placed on a mulched area and the OEPs are inserted into appropriate holes. As shown in FIG. 4, the holes in the weed barrier sheets are sized to tightly fix the OEP in place. This avoids any gap between the weed barrier sheet and the OEP. A larger gap may allow weeds to grow. Once the plant is positioned in the OEP, fresh potting mix should be used to stabilize the plant. This is important since using topsoil from the garden will have tons of weed seeds which will germinate within the OEP.

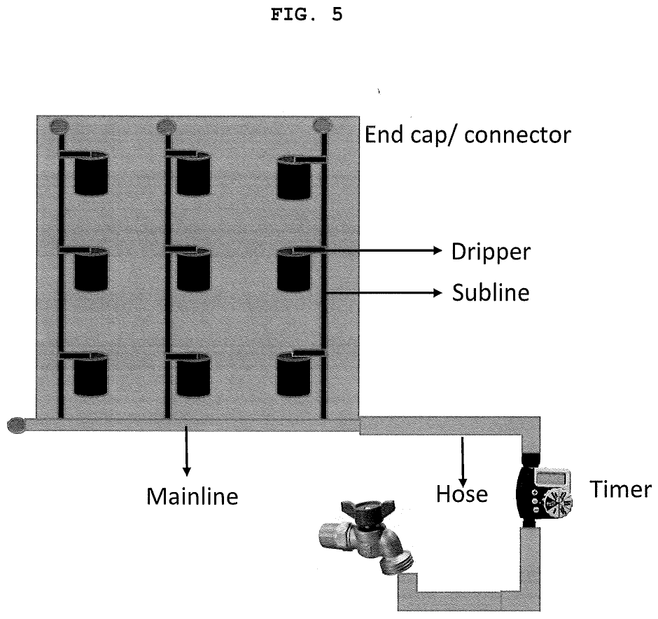

Referring to FIG. 5, the weed control system can be used in conjunction with drip irrigation and automatic watering by a timer connected to the system. This will further help to precisely water the root zone thus conserving water.

While the foregoing invention has been described in some detail for purposes of clarity and understanding, it will be appreciated by one skilled in the art from a reading of this disclosure that various changes in form and detail can be made without departing from the true scope of the invention and appended claims.

1. A weed barrier system comprising one or more weed barrier sheets of flexible polymer or plant material impervious to light and water and ranging in thickness from 0.25 mm to 3.0 mm with precut holes ranging in size between about 0.5 inches and about 10 inches to grow a single to more than 100 plants of different sizes.

2. The weed barrier system of claim 1 wherein the weed barrier sheet comprises natural rubber, vulcanized rubber, neoprene, EPDM, silicon, thick plastic made of polypropylene, polyethylene, polyamide, polystyrene, or mixtures of these or woven sheets made grass, leaf, wood, bamboo or other plant materials.

3. The weed barrier system of claim 1 wherein two or more weed barrier sheets are joined by staples to cover a larger area.

4. The weed barrier system of claim 1 wherein weed barrier sheet is provided on a roll to cover agricultural lands to growing vegetables and/or small fruits.

5. The weed barrier system of claim 1 wherein the weed barrier sheet is modified to cover areas below already growing plants or trees to prevent or inhibit weed interference.

6. The weed barrier system of claim 1 wherein the weed barrier sheet is modified in appearance to resemble mulch or grass or alternative different contours and/or shades of color.

7. The weed barrier system of claim 1 wherein the weed barrier sheet further comprises an agent to repel rabbits, deer and other small animals from the weed barrier system.

8. The weed barrier system of claim 1 wherein the weed barrier sheet is modified to act as a reservoir for small animal repelling agents.

9. The weed barrier system of claim 1 further comprising one or more open ended planters (OEPs).

10. The weed barrier system of claim 9 wherein the OEP is comprised of polyvinyl chloride (PVC), polypropylene, polyethylene, polyamide or polystyrene or mixtures thereof, high density polyethylene (HDPE), galvanized or non-galvanized iron or stainless steel, clay, ceramic, terracotta, wood, bamboo or another plant material.

11. The weed barrier system of claim 9 wherein the OEP is sized to fit in the holes of the weed barrier sheet.

12. A weed barrier system comprising one or more open ended planters (OEPs).

13. The weed barrier system of claim 12 wherein the OEP is used in conjunction with a fabric or fiber based weed barrier.

14. The weed barrier system of claim 12 wherein size of the OEPs ranges from about 0.5 inches to about 10 inches.

15. The weed barrier system of claim 12 wherein the OEP is modified to allow automatic watering and fertilizing for drip irrigation of individual plants.

16. The weed barrier system of claim 12 wherein the OEP is modified to retain more water or prevent evaporation of water from the surface and/or to act as a reservoir or serve as a base for an additional reservoir for agents used to repel rabbit, deer and other small animals in the garden.

17. The weed barrier system of claim 12 wherein the outer surface of the OEP above the soil is modified to capture wind-blown seeds.

18. The weed barrier system of claim 9 further comprising a drip irrigation system.

19. The weed barrier system of claim 18 wherein the drip irrigation system has a timer for automatic watering.
